(19) United States
(12) Patent Application Publication
(10) Pub. No.: US 2022/0114472 A1
(43) Pub. Date: Apr. 14, 2022

(54) SYSTEMS AND METHODS FOR GENERATING MACHINE LEARNING-DRIVEN TELECAST FORECASTS

(71) Applicant: NBCUniversal Media, LLC, New York, NY (US)

(72) Inventors: Cameron Davies, Frisco, TX (US); Marco Antonio Morales Barba, Ridgewood, NY (US); David L. Synder, Naperville, IL (US); Tong Jian, Long Island City, NY (US); Jiabin Chen, Tenafly, NJ (US); Soudeep Deb, Bangalore (IN); Nana Yaw Essuman, Dumfries, VA (US); Jiacheng Wang, Chicago, IL (US)

(21) Appl. No.: 17/066,279

(22) Filed: Oct. 8, 2020

(51) Int. Cl. G06N 20/00; G01W 1/10; G06K 9/62

(52) U.S. Cl. CPC G06N 20/00; G06K 9/6256; G01W 1/10

(57) ABSTRACT

Systems and methods for generating telecast forecasts is provided. An automated forecasting system uses machine learning-driven a forecast model for generating forecast for various telecasts varying periods of time. Estimate values that are used to generate the forecasts may be determined based on deriving trends and correlations from telecasts data using machine learning. The forecasting system may compare estimate values and actual values associated with the various telecasts and subsequently update the forecast model based on the comparison. The forecast model may be displayed on an electronic device of a client electronic device and may be updated or influenced by telecast providers.

### BACKGROUND

The present disclosure relates generally to telecast forecasts. More particularly, the present disclosure relates to systems and methods for generating telecast forecasts using machine learning.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Telecast providers often determine forecasts or estimate values (e.g., number of viewers, sales values) for scheduled telecasts (e.g., TV shows, movies, advertisements, or any other media content) based on analyzing different types of data that are relevant to telecasts over varying periods of time. In turn, telecast providers may use these forecasts estimate values to generate an appropriate telecast streaming schedule. However, determining forecast via a manual process is not efficient and may result in a loss of time, resources, and revenue for telecast providers. Manual calculations may also be infeasible given the large data sets and complex computations. Therefore, an automated forecasting system that uses a machine learning-driven forecasting model to predict trends and generate forecasts may reduce calculation time spent on generating the forecasts while increasing forecast accuracy, thereby benefitting telecast providers and advertisers looking to market their content.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a tangible, non-transitory, machine-readable medium, which includes machine readable instructions, is provided. When executed by one or more processors of a machine, the machine-readable instructions may cause the machine to: access, at the machine, data related to content; determine, using a forecasting engine, forecast information for a predetermined time period for the content, wherein the forecast information comprises a number of viewers, a number of impressions, a sales value, or any combination thereof; and provide, to a client device, the forecast information.

In a further embodiment, a method for training a forecast model is provided. The processor may acquire a first set of data related to content and determine a first set of parameters for an exponentially decay covariance algorithm (EDCA) based on the first set of data. The processor may generate one or more estimate values based on the first set of parameters and the EDCA and perform a comparison between the one or more estimate values and one or more actual values associated with a second set of data related to the content. After performing the comparison, the processor may determine a second set of parameters based on the second set of data in response to determining a difference between the one or more estimate values and the one or more actual values is greater than a threshold value. Additionally, the processor may update the forecast model and the EDCA with the second set of parameters.

In an additional embodiment, a forecasting engine may comprise one or more processors and one or more memory devices configured to store instructions. When the instructions are executed by the one or more processors, the one or more processors to access data related to content. Based machine learning circuitry and using the forecasting engine, the one or more processors may determine forecast information for a predetermined time period for the content. The forecast information comprises a number of viewers, a number of impressions, a sales value, or any combination thereof. The one or more processors may provide the forecast information to a client device.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 illustrates a forecasting system that generates telecast forecasts using machine learning, in accordance with an embodiment of the present disclosure;

FIG. 2 is a flowchart associated with a machine learning algorithm from the forecasting system of FIG. 1, in accordance with an embodiment of the present disclosure;

FIG. 3 is a flowchart associated with a validation tool from the forecasting system in FIG. 1, in accordance with an embodiment of the present disclosure;

FIG. 4. is a graphical user interface (GUI) that depicts data associated with the forecasting system of FIG. 1, in accordance with an embodiment of the present disclosure;

FIG. 5 is the GUI of FIG. 4 that depicts an enlarged view of a planning panel, in accordance with an embodiment of the present disclosure;

FIG. 6 is the GUI of FIG. 4 that depicts a trend line associated with data from a forecast model in the planning panel, in accordance with an embodiment of the present disclosure;

FIG. 7 is the GUI of FIG. 4 that depicts a trend line associated with data from an influenced forecast model in the planning panel, in accordance with an embodiment of the present disclosure;

FIG. 8 is the GUI of FIG. 4 that depicts a trend line associated with data from the forecast model of FIG. 6 and data from the influenced forecast model of FIG. 7 in the planning panel, in accordance with an embodiment of the present disclosure;

FIG. 9 is the GUI of FIG. 7 that further depicts a trend line associated with data from a long-range forecast model in the planning panel, in accordance with an embodiment of the present disclosure;

FIG. 10 is the GUI of FIG. 6 that further depicts a trend line using data from the long-range forecast model in the planning panel, in accordance with an embodiment of the present disclosure;

FIG. 11 is the GUI of FIG. 4 that depicts a trend line using data from the long-range forecast model of FIG. 9 and data from an influenced, long-range forecast model, in accordance with an embodiment of the present disclosure;

FIG. 12 is the GUI of FIG. 11 that further depicts a trend line using data from an influenced, long range forecast model from a present quarter of time, in accordance with an embodiment of the present disclosure;

FIG. 13 is the GUI of FIG. 10 that further depicts an enlarged, pacing view of FIG. 12, in accordance with an embodiment of the present disclosure;

FIG. 14 is the GUI of FIG. 4 that depicts an influencing panel, in accordance with an embodiment of the present disclosure;

FIG. 15 is the GUI of FIG. 4 that depicts a history panel, in accordance with an embodiment of the present disclosure;

FIG. 16 is the GUI of FIG. 4 that depicts a records panel, in accordance with an embodiment of the present disclosure;

FIG. 17 is a flowchart associated with determining forecasting information via the forecasting system of FIG. 1, in accordance with an embodiment of the present disclosure.

FIG. 18 is a flowchart associated with updating the forecasting system of FIG. 1 based on a new set of parameters, in accordance with an embodiment of the present disclosure; and

FIG. 19 illustrates example elements that are a part of the forecasting system of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. It should be noted that the term “multimedia” and “media” may be used interchangeably herein.

Moreover, the embodiments of the disclosure will be best understood by reference to the drawings, wherein like parts are designated by like numerals throughout. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. In some cases, well-known features, structures or operations are not shown or described in detail. Furthermore, the described features, structures, or operations may be combined in any suitable manner in one or more embodiments. The components of the embodiments as generally described and illustrated in the figures could be arranged and designed in a wide variety of different configurations.

As discussed in greater detail below, the present embodiments described herein improve efficiencies in generating forecasts for telecasts (e.g., TV shows, advertisements, movies) over varying periods of time (e.g. week, month, year). Telecast providers may use the forecasts to as a metric for predicting the number of viewers for purposes of ad sales, to generate appropriate streaming schedules for various telecasts, or to make effective changes to the streaming schedules. The forecasts or estimate values may be generated based on machine-learning. These estimate values may include a number of viewers, a number of impressions, sales values, and the like. The number of impressions may be defined as the number of exposures of a viewer to a telecast over a period of time (e.g., a quarter, a month, a year). For example, a particular telecast may have 5,000 viewers over a certain time period. If each of the 5,000 viewers views or is exposed to the particular telecast three times over the certain time period, then the number of impressions may be 15,000 for the particular telecast.

The estimate values and forecasts may be determined based on analyzing data relevant to the various telecasts. Such data may range from the trivially small in size to those that may encompass tens of millions of records and data points, or more. As the number of telecasts increase, the number of records and data sources associated with the telecasts increase as well. Given the large sets of data related to the telecast and corresponding complex computations, manual calculations of estimate values (e.g., 1,000 calculations per day, 10,000 calculations per day, 100,000 calculations per day) and generating forecasts may not be feasible. Manually estimating telecast values and predicting forecasts may involve an increased time spent on estimation, have limited forecast accuracy, and be susceptible to biases (e.g., recency bias). Further, manual estimation may be inefficient in comparing estimate and actual values for telecasts as well as in predicting trends and correlations from telecast data. Recency bias may be defined as determining estimate values based on the most recent telecast data while neglecting long-term trends and other relevant telecast data from past time periods. That is, recency bias may prevent efficient analysis of correlations and trends generated from a vast amount of data as well as tracking estimate and actual values over varying points in time and across varying streaming schedules. These deficiencies of manual estimation may inflate forecast errors, thereby inhibiting telecast providers from accurately predicting a number of viewers for a telecast. Further, machine-based processing may provide insight that may not be attained via human estimating, by relying on complex data patterns/relationships that may not be conceived in the human mind.

As a result, an automated system that uses machine learning to generate telecast forecasts may reduce calculation time spent on estimating forecasts while increasing forecast accuracy. The automated system may receive data relevant to the telecasts via various data sources (e.g., databases). The automated system may extract metadata. In some instances, a third-party tool corresponding to the automated system may extract and clean the data. Cleaning the data may involve organizing data with respect to time or with respect to various metrics such as telecast name, daypart, and the like. Daypart may be defined as a block of time (e.g., primetime, early morning, daytime, late news) associated with the schedule and delivery of various telecasts. In some embodiments, the organized data for each telecast may be stored in a time-series database to provide more efficient querying operations of the organized data and performing analysis of trends and correlations.

The automated system may perform machine learning on the clean data to determine estimate values and generate forecasts. For example, an exponential decay covariance algorithm (EDCA) may be used to determine estimate values and generate forecasts based on the clean data. In accordance with this algorithm, an overall mean, deviations, time-dependent observations, and trends may be determined via machine learning. In some embodiments, weights may be applied to parameters (e.g., type of content, duration, number of viewers, number of impressions, frequency, accuracy) associated with telecasts. Weights may refer to the relative importance or relative priority associated with the parameters. For example, when scheduling TV show re-runs, the number of impressions or the number of viewers for telecasts may be weighted heavily compared to other parameters. Based on the weights and trends, the automated system may use a forecast model or forecast engine to generate telecast forecasts over varying periods of time. In some embodiments, the machine learning based forecast model may be configurable via input from the telecast provider. In other embodiments, the forecast model may be updated based on comparing actual values with estimate values with respect to TV viewership. Continuously updating the forecast model based on actual values and other relevant data improves the forecast accuracy over time.

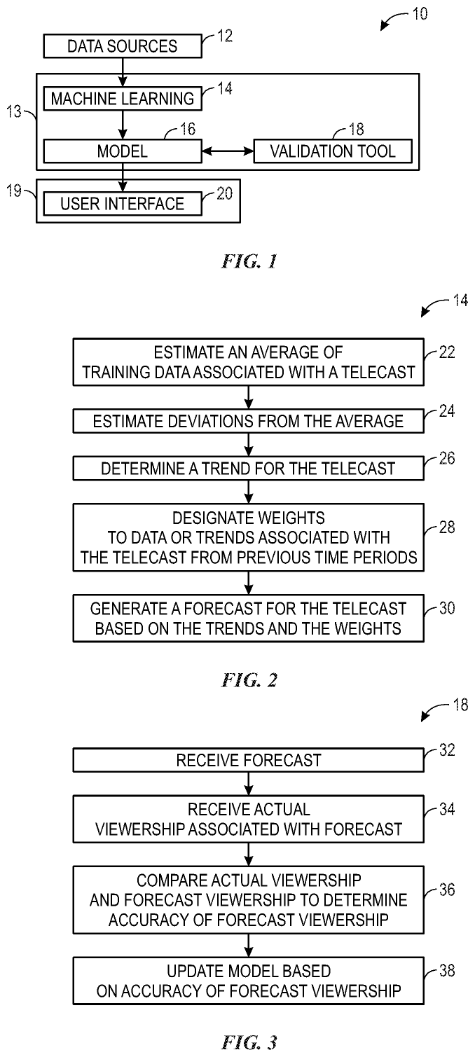

With the preceding in mind, the following figures relate to the automated system and process of generating telecast forecasts via machine learning. Turning now to FIG. 1, a schematic diagram of an embodiment of a forecasting system 10 where embodiments of the present disclosure may operate, is illustrated. The forecasting system 10, is an automated and, in some embodiments, centralized system, may receive raw data from a variety of data sources 12 (e.g., databases, online services) associated with a number of telecasts over a varying time frames (e.g., 6000 telecasts per month). In some embodiments, the forecasting system 10 may clean and shape the raw data using an extract, transform, load (ETL) procedure, using forecasting circuitry 13. The ETL procedure may involve copying the raw data from the variety of data sources 12 into the forecasting circuitry 13.

In some embodiments, cleaning the data involves organizing data with respect to time or with respect to various metrics such as telecast name, daypart, and the like. Daypart may be defined as a block of time (e.g., primetime, early morning, daytime, late news) associated with the schedule and delivery of various telecasts. In some embodiments, the organized data for each telecast may be stored in a time-series database to provide efficiency in performing querying operations of the organized data as well as performing analysis of trends and correlations. Further, the raw data may be shaped or transformed to meet appropriate data forms (e.g., log files). Additionally, the raw data may be extracted for metadata. The cleaned, shaped, and extracted raw data from the variety of data sources 12 may be referred to as clean data as set forth herein.

The forecasting circuitry 13 may perform machine learning on the clean data. As used herein, the forecasting circuitry 13 may include any suitable processor that runs software to generate forecasts. Machine learning circuitry 14 (e.g., circuitry used to implement machine learning algorithms or logic) may access the clean data to identify patterns, correlations, or trends associated with the clean data. As used herein, the machine learning circuitry 14 may include any suitable processor that runs software to perform machine learning on the clean data to determine correlations and trends from the clean data. Because the original data is sourced from a multitude of diverse online services and databases, new data patterns not previously attainable may emerge. As used herein, machine learning may refer to algorithms and statistical models that computer systems use to perform a specific task with or without using explicit instructions. For example, a machine learning process may generate a mathematical model based on a sample of the clean data, known as “training data,” in order to make predictions or decisions without being explicitly programmed to perform the task.

Depending on the inferences to be made, the machine learning circuitry 14 may implement different forms of machine learning. For example, in some embodiments (e.g., when particular known examples exist that correlate to future predictions or estimates that the machine learning circuitry 14 will be tasked with generating) supervised machine learning may be implemented. In supervised machine learning, the mathematical model of a set of data contains both the inputs and the desired outputs. This data is referred to as “training data” and is essentially a set of training examples. Each training example has one or more inputs and the desired output, also known as a supervisory signal. In a mathematical model, each training example is represented by an array or vector, sometimes called a feature vector, and the training data is represented by a matrix. Through iterative optimization of an objective function, supervised learning algorithms learn a function that can be used to predict the output associated with new inputs. An optimal function will allow the algorithm to correctly determine the output for inputs that were not a part of the training data. An algorithm that improves the accuracy of its outputs or predictions over time is said to have learned to perform that task.

Supervised learning algorithms include classification and regression. Classification algorithms are used when the outputs are restricted to a limited set of values, and regression algorithms are used when the outputs may have any numerical value within a range. Similarity learning is an area of supervised machine learning closely related to regression and classification, but the goal is to learn from examples using a similarity function that measures how similar or related two objects are. It has applications in ranking, recommendation systems, visual identity tracking, face verification, and speaker verification.

In some embodiments, EDCA may be an example of supervised machine learning. In accordance with this algorithm, an overall mean, deviations, time-dependent observations, and trends may be determined via machine learning. A more in-depth discussion related to EDCA will be provided below.

Additionally and/or alternatively, in some situations, it may be beneficial for the machine-learning circuitry to utilize unsupervised learning (e.g., when particular output types are not known). Unsupervised learning algorithms take a set of data that contains only inputs, and find structure in the data, like grouping or clustering of data points. The algorithms, therefore, learn from test data that has not been labeled, classified or categorized. Instead of responding to feedback, unsupervised learning algorithms identify commonalities in the data and react based on the presence or absence of such commonalities in each new piece of data.

Cluster analysis is the assignment of a set of observations into subsets (called clusters) so that observations within the same cluster are similar according to one or more predesignated criteria, while observations drawn from different clusters are dissimilar. Different clustering techniques make different assumptions on the structure of the data, often defined by some similarity metric and evaluated, for example, by internal compactness, or the similarity between members of the same cluster, and separation, the difference between clusters. Other methods are based on estimated density and graph connectivity.

In other embodiments, the machine learning circuitry 14 may use other algorithms including but not limited to a univariate autoregressive integrative moving average (ARIMA) algorithm, a multivariate ARIMA algorithm, a regression algorithm (e.g., LASSO, Ridge, linear model), and XGBoost. While EDCA is capable of determining estimate values or forecast information (e.g., predicted number of TV viewers) based on monitoring data from two or more TV shows simultaneously, univariate and multivariate, ARIMA may be capable of handling data from one TV show at a time. Further, in general, the regression algorithm may provide forecast information based on determining correlations between a dependent variable and one or more independent variables. In some embodiments, XGBoost may be used to provide forecast information based on unstructured data.

Predictions or estimates may be derived by the machine learning circuitry 14. For example, groupings and/or other classifications of users may be identified, influencers of users and/or groups may be identified, and/or predicted preferences of users, groups of users, and/or influencers may be identified. The data predictions or estimates may be provided to downstream applications, which may perform actions based upon the data predictions or estimates. For example, as will be discussed in more detail below, particular graphical user interface (GUI) features may be rendered based upon the data predictions or estimates, particular application features/functions may be enabled based upon the data predications or estimates, etc. This may greatly enhance telecast providers with scheduling services and/or applications, which may perform actions based upon groupings and/or influencer determinations that were not previously discernable prior to the techniques provided herein.

In addition to deriving predictions or estimates, the machine learning circuitry 14 may also be used to apply weights to parameters (e.g., type of content, duration, number of viewers, number of impressions, and so forth) associated with telecasts. Weights may refer to the relative importance or relative priority associated with the parameters. For example, when scheduling TV show re-runs, the number of impressions or the number of viewers for telecasts may be weighted heavily compared to other parameters. Based on the weights and trends, the forecasting circuitry 13 may generate forecasts over varying periods of time by using a forecast model developed via machine learning. In some embodiments, respective weights associated with parameters may have values between 0 and 1. In additional embodiments, parameters that are expected to contribute more heavily to the accuracy of forecasts may be given higher weights.

For example, parameters such as which celebrities are guest starring in a telecast (e.g., talk show) may affect generating forecasts. The machine learning circuitry 14 may develop a forecast model for a particular telecast (e.g., talk show) based on estimate values (e.g., number of viewers and impressions without any celebrity guest stars on the talk show). However, if the machine learning circuitry 14 receives additional relevant data associated with the particular talk show, such as a popular celebrity expected to be on the talk show this year, then the machine learning circuitry 14 may generate forecasts based on this additional relevant data.

Based on analyzing relevant data associated with the popular celebrity and determining correlations from the analyzed data over varying time periods, the machine learning circuitry 14 may use an updated forecast model that considers the popular celebrity parameter. For example, if the relevant data indicates that the number of viewers increased compared to average number of viewers for the talk show when the popular celebrity starred in the talk show last year, then the parameter associated with the popular celebrity may be associated with a higher weight. Upon applying a higher weight to the popular celebrity parameter, the machine learning circuitry 14 may generate forecasts with a greater number of viewers and impressions when the popular celebrity guest-stars on the talk show next year compared to the original estimate values (e.g., number of viewers and impressions without any celebrity guest stars on the talk show).

In another example, parameters associated with type of content (e.g., whether a telecast is a re-run or a live show) as well as accuracy may affect developing forecast model. For example, a live show may be susceptible to more errors compared to a re-run. Therefore, parameters associated with accuracy and whether the telecast is a live show may be weighted more heavily because more accurate forecast models are beneficial to telecast providers with respect to live shows compared to re-runs.

Based on the predictions and estimate values for telecasts, the machine learning circuitry 14 may apply a forecasting model 16 for respective telecasts over a varying period of time. For example, the forecasting model 16 may include estimates for the number of impressions for a particular telecast over the next two years. As mentioned previously, the forecasting model 16 may be configurable via input from the telecast provider. For example, the machine learning circuitry 14 may generate forecasts that indicate 5 thousand impressions over the next two years for a particular telecast using the forecasting model 16. However, after providing a reason, a research team associated with the telecast provider may also be able to influence or update the estimate values generated by the forecast model 16. In one example, the research team may update the forecast model 16 by inputting an influence of 8 thousand impressions over the next two years. In turn, the machine learning circuitry 14 may generate forecasts associated with the 8 thousand impressions over the next two years. Influencing the forecasting model 16 will be discussed in more detail below.

In other embodiments, the forecasting model 16 may be updated based on a validation tool 18 that compares actual values and estimate values associated with a particular telecast. For example, the validation tool 18 may collect actual values such as Viewers Per Viewing Household (VPVH), which is the average number of people viewing a program or using television during a particular time period among households that have at least one TV set turned on. After comparing the actual values with the estimate values and determining error (e.g., absolute error, percent error, approximate error), the validation tool 18 may update the forecast model based on the comparison. Further details related to the validation tool 18 will be provided below.

As suggested above, the machine learning circuitry 14 may use the forecast model 16 to generate predictions or estimates, which may be displayed on an electronic display of a client electronic device 19 via a GUI 20. The GUI 20 provides the telecast provider a centralized form to analyze the forecasting model 16, view a history of estimate and actual values, and influence or update the forecast model 16.

With the preceding in mind, FIG. 2 is a flow chart associated with using machine learning circuitry 14 on the clean data associated with various telecasts. In particular, the machine learning algorithms may incorporate an EDCA algorithm to improve forecast accuracy. As mentioned above, this supervised machine learning algorithm generates a mathematical model based on a sample of the clean data, known as “training data,” in order to make predictions or decisions without being explicitly programmed to perform the task. EDCA involves estimating an overall mean or average of the training data given certain parameters (block 22). For example, the machine learning circuitry 14 may determine the average number of impressions for a particular TV show over the past five years.

At block 24, EDCA may estimate deviations from the mean or average due to cyclical patterns (e.g., months days of the week). For example, estimate deviations may account for a lower number of impressions or viewers during the summer months due to past data indicating that viewers are out of the household more frequently, and thus watch less TV during the summer months. On the other hand, estimate deviations may account for a higher number of impressions or viewers during the winter months due to past data indicating that viewers are in the household more frequently, and thus watch more TV during the winter months. In an additional example, popular events may impact estimate deviations. For example, a telecast may experience a higher number of viewers or impressions when following a popular event (e.g., Super Bowl) compared to the estimate mean or average number of viewers or impressions for the telecast. In some embodiments, EDCA may use estimate mean and estimate deviations to determine various trends and correlations associated with telecast data.

In additional embodiments, by analyzing data associated with telecasts from past and present time periods, EDCA may also estimate various trends and determine correlations (block 26). For example, the machine learning circuitry 14 may determine that viewers have been watching less content on their TV sets (e.g., cord cutting) in the past five years compared to the previous five years due to a rise in alternative internet streaming services. Cord cutting may be an example of change-points in time trends that better capture anomalies or changes in estimate mean values of TV viewership over time. In addition to change-points in time trends, the machine learning circuitry 14 may determine temporal changes, permanent changes, anomalies, and the like associated with estimate mean values (e.g., number of viewers or impressions) over time. In some embodiments, the machine learning circuitry 14 may compare trends of correlations from data associated with different telecasts. For example, if the number of impressions for a first talk show is higher during the winter months, then the number of impressions for a second talk show may be impacted or may vary based on the correlation associated with the first talk show.

In additional embodiments, the machine learning circuitry 14 may generate forecasts based on time dependent observations by comparing data over a period of weeks, months, years, and the like. For example, the machine learning circuitry 14 may determine that on average a telecast streaming a popular award show may be generally viewed by a higher number of viewers compared to the telecast streaming a re-run. However, the machine learning circuitry 14 may also consider that viewership associated with the popular award show has declined in recent years. For example, the number of viewers may be 2 million for each streaming of the popular award show in the past five years compared to 4 million in the previous five years. Therefore, while the number of viewers may be forecasted to be higher for the popular award show compared to a streaming of a re-run, the machine learning circuitry 14 may determine that the number of viewers may not be as high in the future for the popular award show compared to past years. Analyzing time dependent observations enables the machine learning circuitry 14 to generate more accurate forecasts using an updated forecast model 16.

Overall, EDCA is suitable for generating forecasts related to TV viewership data. For example, EDCA may analyze cord cutting information, telecast data across various seasons (e.g., comparing TV show from present season and past season), telecast data within a season (e.g., comparing a fourth episode streamed Monday and a third episode streamed Monday), and data associated with interruptions (e.g., Super Bowl) in a season to generate more accurate forecasts.

As mentioned above, the machine learning circuitry 14 may also be used to apply weights to parameters (e.g., type of content, duration, number of viewers, number of impressions, and so forth) associated with telecasts (block 28). Weights may refer to the relative importance or relative priority associated with the parameters. For example, when scheduling TV show re-runs, the start time may be weighted more heavily compared to other parameters (e.g., the day(s) of week TV show is streamed). Based on the weights and trends, the forecasting system 10 may generate a forecast model over varying periods of time (block 30). In some embodiments, respective weights associated with parameters may have values between 0 and 1. In additional embodiments, parameters that are expected to contribute more heavily to the accuracy of forecasts may be given higher weights. In some embodiments, the weights may be dynamically changed by the telecast provider.

With the foregoing in mind, the forecast model 16 may be trained by obtaining a historical set of telecast data (e.g., actual values), determining initial parameters (e.g., type of content, duration, number of viewers, number of impressions) with respect to an exponential decay model to best fit the telecast data, evaluating parameters algorithmically, and testing the parameters against a test sample. The forecast model 16 is trained using a subset of past or historical telecast data, such that an algorithm (e.g., EDCA) may use available structure or information from the past telecast data to create accurate predictions (e.g., estimate values). The forecast model 16 learns from different combinations of information from the past telecast data being added to the algorithm. As such, each combination of information from the past telecast data may produce a different prediction and corresponding estimate values.

Training the forecast model 16 may be defined as the forecast model learning from the past telecast data. The algorithm (e.g., EDCA) may select optimal parameters (e.g., set thresholds for the parameters) based on the learning of the forecast model 16 to minimize error in predictions (e.g., estimate values) after the forecast model 16 has been trained. A best fit model may be selected when the predictions (e.g., estimate values) are compared to a new segment of data that the forecast model 16 has not yet handled or encountered. The best fit model may be selected based on generating predictions with the least amount of error, in which error is the difference between the new segment of data and the predictions (e.g., estimate values). Therefore, the best fit model provides insight on forecast information that is generally relevant for accurate predictions (e.g., estimate values).

After the best fit model has been determined, the best first model and its corresponding data may be stored in the forecasting system 10 for future training and testing of new data. The parameters (e.g., type of content, duration, number of viewers, number of impressions) associated with the best fit model may continuously updated in response to receiving the new data. However, the features

As mentioned previously, after providing a reason, a research team associated with the telecast provider may be able to influence or update the estimate values generated by the forecast model 16. For example, the forecast model 16 may predict 50,000 viewers for a particular TV show each Sunday based on learning data related to past viewership associated with the particular TV show. However, the research team may be aware of new data that may not have been received by the forecast model 16 yet. For example, a popular, one-time broadcast being streamed at the same time as the particular TV show on a particular Sunday may result in a loss of viewers for the particular TV show. Based on this new data, the research team may influence the forecast model 16 by updating the estimate value of 50,000 viewers to 25,000 viewer for that particular Sunday.

However, with respect to EDCA, the ability to influence estimate values or data points may decay over time. Because the most recent forecast information carries more weight compared to past forecast information using EDCA, it may be useful to continuously train the forecast model 16 based on new data. Unlike other algorithms such as ARIMA, EDCA may enable the forecast model 16 to be trained based on data that may be temporally contiguous as well as data that is not temporally contiguous. That is, EDCA is capable of handling both types of data. As such, EDCA provides flexibility in the type of data that may be used for training the forecast model 16. Such flexibility is particularly helpful when using TV data, in which seasons of a TV show do not last a whole year and whose scheduling may vary each year. Further, EDCA may have parameters that are not fixed during an entire training period of the forecast model 16 but rather may change over time. The ability to change parameters over the course of training the forecast model 16 reduces error in estimate values or predictions over time and enhances the forecast model's adaptability with respect to the data used for training. Using EDCA to train the forecast model 16 improves accuracy of estimate values since EDCA is flexible to changes in observed patterns and trends related to telecasts (e.g., TV viewership). In additional embodiments, EDCA may be expressed below as Equation [1]:

Responses (or Estimated Viewership)=Mean+Residual (Exponentially Decaying Covariance)+White Noise [here] [1]

R=[rᵢⱼ]_{TxT} [2]

rᵢⱼ=e^{-α|t}^{ᵢ}^{-t}^{ⱼ}^{|} [3]

Parameters from the above equations may be estimated through Bayesian methods or selected through cross-validation. Values associated with a mean (e.g., expected value), and exponentially decaying covariance may be factors in equation [1] to determine an estimate value (e.g., “R”, response). White noise is variation in the data without a systematic pattern, which is not used for forecasting purposes. The second equation describes an exponentially decaying covariance matrix (“R”) used to estimate covariation between consecutive or non-consecutive observations with more flexibility which typically results in more accurate forecasts. The third equation describes the elements (“r”) in the exponentially decaying covariance matrix with variables such as alpha (α), a first time (tᵢ), and a second time (tⱼ). Each element (“r”)of the exponentially decaying covariance matrix is estimated by calculating the natural logarithm of the product of negative alpha and the absolute value of the difference between the first time and the second time. That is, each element (“r”) may be a correlation between two variables in the covariance matrix. For example, “r” may be a correlation between a first time of a TV show on Monday of last week and a second time of the TV show on Monday of next week. Given the flexibility of this formulation that does not require a fixed temporal distance between the first and second times, a more accurate response may be forecasted. As mentioned previously, the machine learning circuitry 14 may use any combination of the following algorithms: EDCA, univariate or multivariate autoregressive integrated moving average (ARIMA), regression (e.g., linear model, LASSO, Ridge), and XGBoost to calculate the estimate values.

Referring to FIG. 1, the forecasting circuitry 13 also includes a validation tool 18 that may compare the estimate values from the forecast model 16 with actual values associated with a telecast. As such, FIG. 3 is a flowchart that depicts a process, in which the validation tool 18 updates the forecast model 16 based on the actual values. The validation tool receives estimate values associated with the forecast model 16 from the machine learning circuitry 14 (block 32). After receiving the estimate values, the validation tool 18 may glean data for actual values associated with the telecast (block 34). As mentioned above, the validation tool 18 may collect actual values such as VPVH, which is the average number of people viewing a program or using television during a particular time period among households that have at least one TV set turned on.

At block 36, the validation tool may compare the actual values (e.g., actual number of viewers or impressions for a telecast) and the estimated values (e.g., forecasted number of viewers or impressions for the telecasts) for any quantitative difference. If a quantitative difference is determined between the actual values and the estimate values, then the validation tool 18 may determine a rate of change and an error value (e.g., percent error, approximation error). In turn, the validation tool 18 may update the forecast model to reflect the actual values, thereby improving the accuracy of the forecast model 16 (block 38). In some embodiments, updating the forecast model 16 may involve updating the weights as described or directly changing the number of forecasted viewers or impressions associated with a scheduled telecast. Further, assumptions of the model may be modified, based upon the difference between the forecast and the actual viewership. In some embodiments, the assumptions of the model may be modified when a difference between the forecast and the actual viewership meets a threshold difference. In this manner, the model may remain consistent when the forecast has a satisfactory level of accuracy.

In some embodiments, the validation tool 18 may use the following equation to calculate error:

errorᵢₜ^{k}=actualsᵢₜ−forecastᵢₜ^{k}

k<t

In accordance with this equation, the error may be based on the difference between the actual values and the forecast values (e.g., estimate values) over a particular period of time.

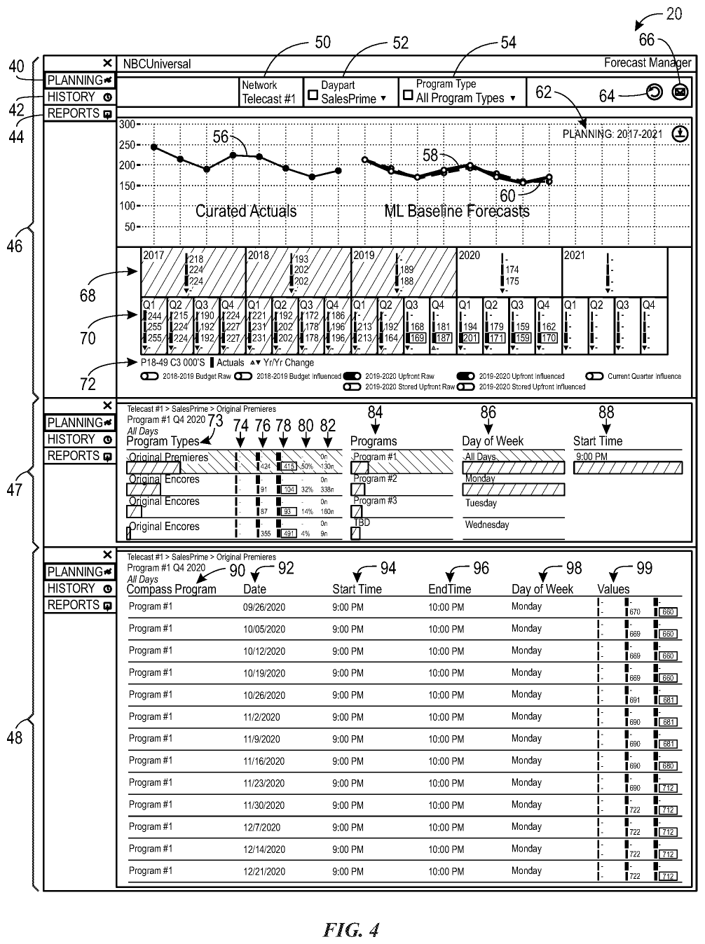

The updated forecast model may be displayed on a GUI. FIG. 4 is an example GUI 20 that depicts data associated with the forecast model 16. The GUI 20 may include various windows (e.g., planning panel, history panel, reports panel), which may be accessed by selecting a respective tab 40, 42, or 44. In particular, FIG. 4 illustrates different portions of the planning panel, initiated by the selection of tab 40. The planning panel includes windows 46, 47, 48. Window 46 may depict either a planning view or a pacing view. Window 47 may depict a program view, and window 48 may depict a telecast view. In FIG. 4, a graphical representation of the forecast model 16 associated with a selected telecast over a selected period of time (e.g., over 3 years) is shown in the planning view.

The GUI 20 includes drop-down menus 50, 52, 54, which may allow a user or a research team associated with the telecast provider to make selections. For example, drop-down menu 50 allows the user to select the type of telecast (e.g., Telecast #1). The drop-down menu allows the user to switch between different telecasts, allowing the user to monitor forecasts for multiple telecasts. In some embodiments, the drop-down menu 50 may allow the user to select more than one telecast. As a result, unlike present machine learning algorithms, EDCA may be capable of monitoring more than one telecast simultaneously and generating forecasts for each of the telecasts. Monitoring more than one telecast simultaneously may be useful in understanding correlations between forecasts of different telecasts.

Further, drop-down menu 52 may allow the user to select a daypart. As mentioned previously, daypart may be defined as a block of time (e.g., salesprime, primetime, early morning, daytime, late news) associated with the schedule and delivery of various telecasts. Drop-down menu 54 may allow the user to select a type of program (e.g., all types of programs, movies, TV shows, and the like.

The planning and pacing views of window 46 may depict a graphical representation of the estimate values from the forecast model 16 and the actual values by displaying the estimate values and the actual values as distinct trend lines. Hovering over particular data points on each trend line displays the estimate or actual value at those particular data points. In some embodiments, the graphical representation may be a line graph associated with the number of impressions over time (e.g., year). The actual values may be depicted as trend line 56 while the estimate values may be depicted as trend line 58. As mentioned previously, the user or the research team may influence or update the forecast model 16 by inputting a modified estimate value via the GUI 20. This modified estimate value may differ from the estimate value generated by the machine learning circuitry 14 using the forecast model 16 prior to being updated or influenced. In some embodiments, the dashed trend line 60 represents the influenced values associated with the influenced forecast model 16 in FIG. 4.

In section 68 within the planning view, actual values, estimate values, and influenced values may be listed over various years while at section 70, actual values, estimate values, and influenced values may listed over various quarters (e.g., first quarter, second quarter) for a particular year. Further, section 72 may allow a user to select features that display various forecasting data (e.g., estimate values, influenced values, long-range values, long-range influenced values, present quarter influenced values, and so forth) as trend lines on the line graph. Each feature provided in section 72 will be described in more detail below. The long-range values and long-range influenced values may be analyzed to compare properties (e.g., aggressive behavior) of the forecast model 16 in comparison to the actual values over a greater period of time.

The planning view may display trend lines associated with the actual values and forecasted values (estimate values, influenced values) adjacent to each other. Meanwhile, the pacing view may overlay trend lines associated with the actual values and forecasted values (estimate values, influenced values), allowing the user to compare the accuracy of the forecasted values in comparison to the actual values. In the planning and pacing views, the user may influence the forecast model 16 by selecting (e.g., double clicking) an estimate value from sections 68 and 70 and changing the value. In some embodiments, double clicking an estimate value from sections 68 and 70 directs the user to an influencing panel, which will be discussed in greater detail below. Further, at section 62, the type of view (e.g., planning or pacing) and time period (e.g., 2017-2021) is depicted. The planning and pacing views may also include a back button 64 and a mail button 66. The back button 64 may allow the user to view a previous view, and the mail button 66 may allow the user to export the visual data and other information from the planning panel as an email.

Further, window 47 of the planning panel may depict a program view. The program view may display data related to different types programs (e.g., movies, TV shows, original premiers, original encores, special, and the like) associated with a telecast. In the program view, information may be categorized based on the type of program 73 (e.g. original premiers, original encores, movies, special). Each type of program 73 may be further categorized based on actual values 74, influenced values 76, estimate values 78, percent composition 80 of each type of program, and duration 82 (e.g., minutes, hours). Additional information in the window 47 may include name of particular programs 84, frequency 86 of streaming the particular program 84 (e.g., Mondays, everyday), start time of the particular program 88, and the like. The type of program 73 and name of programs 84 may include shaded bars that depict the relative composition of each particular program relative to the total composition. For example, for various types of programs 73, the telecast may include a greater number of original premiers compared to original encores, movies, or specials.

In some embodiments, the user may also influence or update the forecast model 16 by selecting (e.g., double clicking) an estimate value 78 and changing the value. In some embodiments, double clicking an estimate value 78 may direct the user to an influencing panel. In further embodiments, the planning panel also includes window 48 which may include the telecast view. The telecast view may categorize information related to a particular program 90 based on date 92, start time 94 and end time 96 of streaming the particular program 90, day of week 98 associated with streaming the particular program 90, and values 99 (e.g., actual values, estimate values, influences values) associated with the particular program 90.

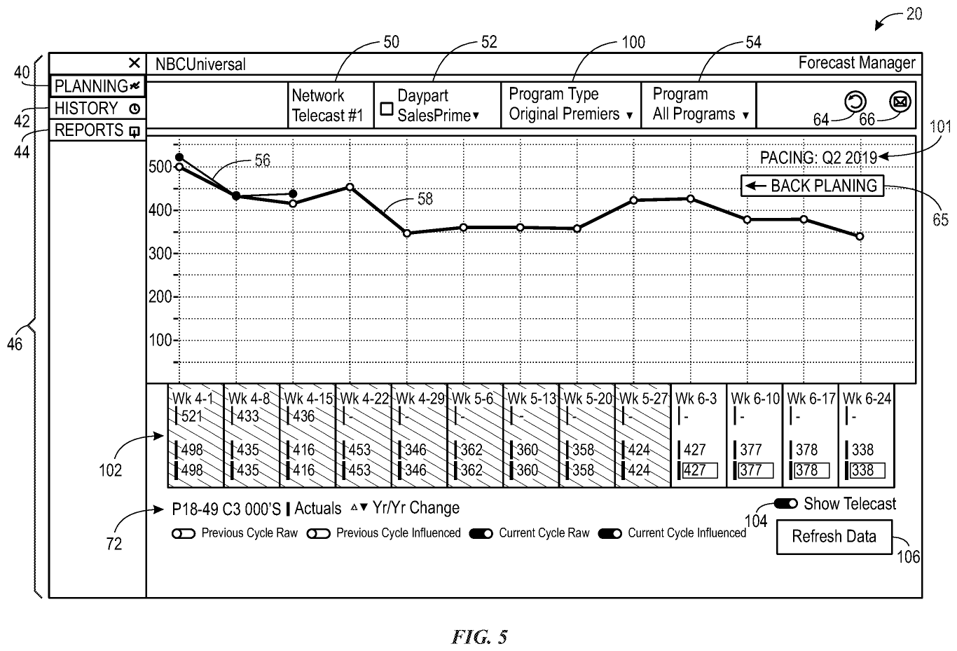

FIG. 5 is the GUI 20, that depicts an enlarged view of the window 46. In particular, the pacing view is depicted in the window 46. The trend line 56 associated with the actual values may be overlaid on top of the trend line 58 associated with the forecasted values (e.g., estimate values, influenced values) are overlaid. As mentioned previously, such overlaying provides ease in comparing the accuracy of the forecasted values in comparison to the actual values. As indicated by 101, the pacing view is depicted for a particular quarter (e.g., second quarter). FIG. 5 also includes additional features not depicted in the GUI 20 of FIG. 4. For example, a drop-down menu 100 may allow a user to select a type of program (e.g., original premiers, original encores, movies, special). Clicking 65 may enable a user to return to the planning view depicted in FIG. 4. At 104, the user may be able to view the telecast, and clicking 106 may refresh the information on window 46.

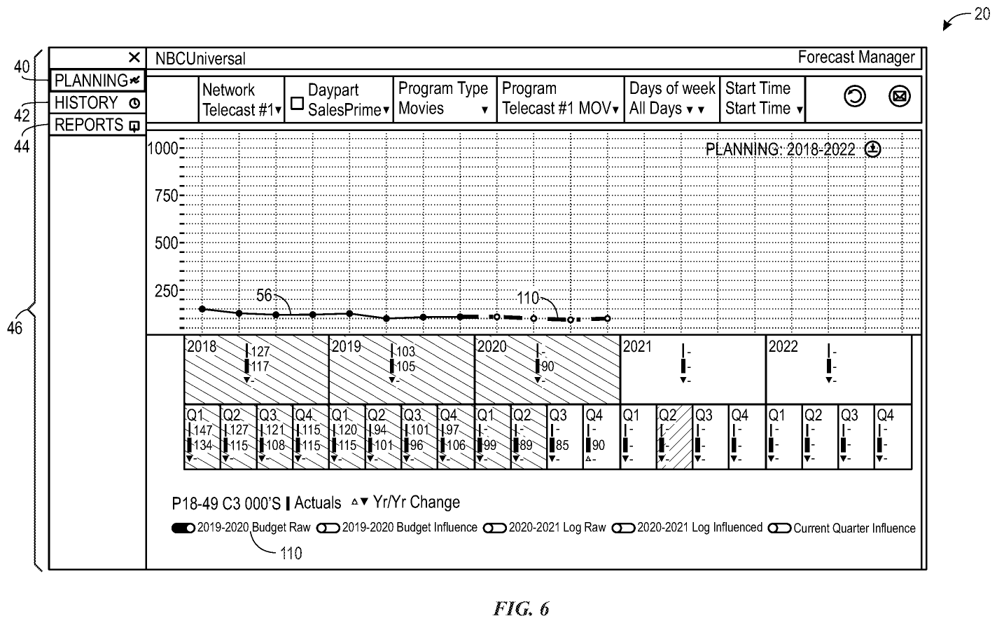

FIG. 6 is the GUI 20 that depicts the above-mentioned line graph with a trend line associated with estimate values from the forecast model 16 in the planning view of window 46, in accordance with an embodiment of the present disclosure. By selecting 110, the trend line 56 associated with the actual values and the trend line 110 associated with the estimate values from the forecast model 16 are depicted over a span of time.

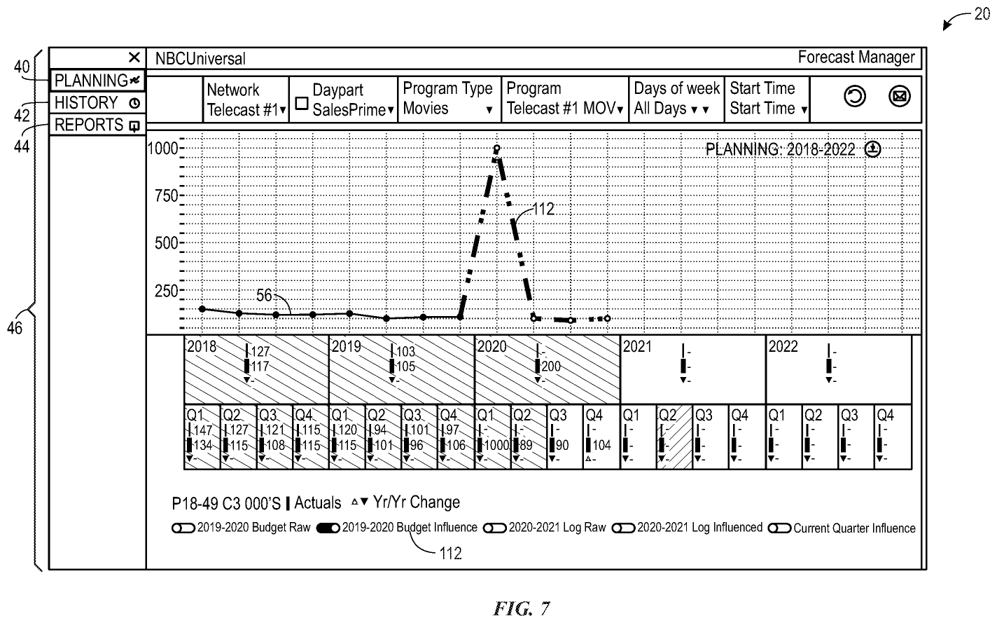

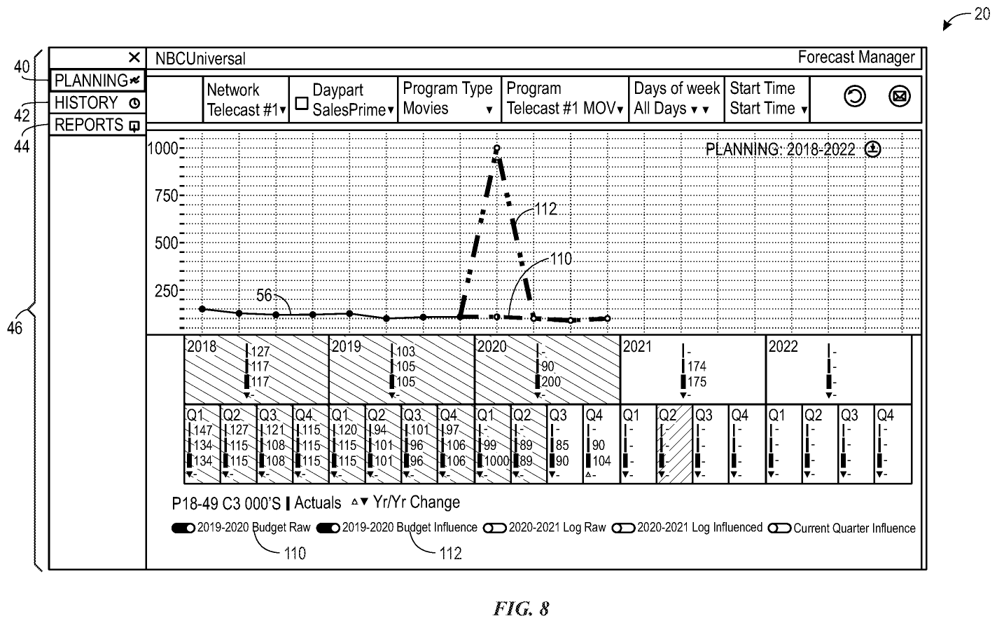

FIG. 7 is the GUI 20 that depicts a trend line using influenced values from an influenced forecast model in the planning view of window 46, in accordance with an embodiment of the present disclosure. By selecting 112, the trend line 56 associated with the actual values and the trend line 112 associated with the influenced values from an influenced forecast model are depicted over a span of time.

FIG. 8 is the GUI 20 that depicts a trend line using estimate values from the forecast model 16 and influenced values from the influenced forecast model in the planning view of the window 46, in accordance with an embodiment of the present disclosure. By selecting 110 and 112, the trend line 56 associated with the actual values, the trend line 110 associated with the estimate values from the forecast model 16, and the trend line 112 associated with the influenced values from the influenced forecast model are depicted over a span of time.

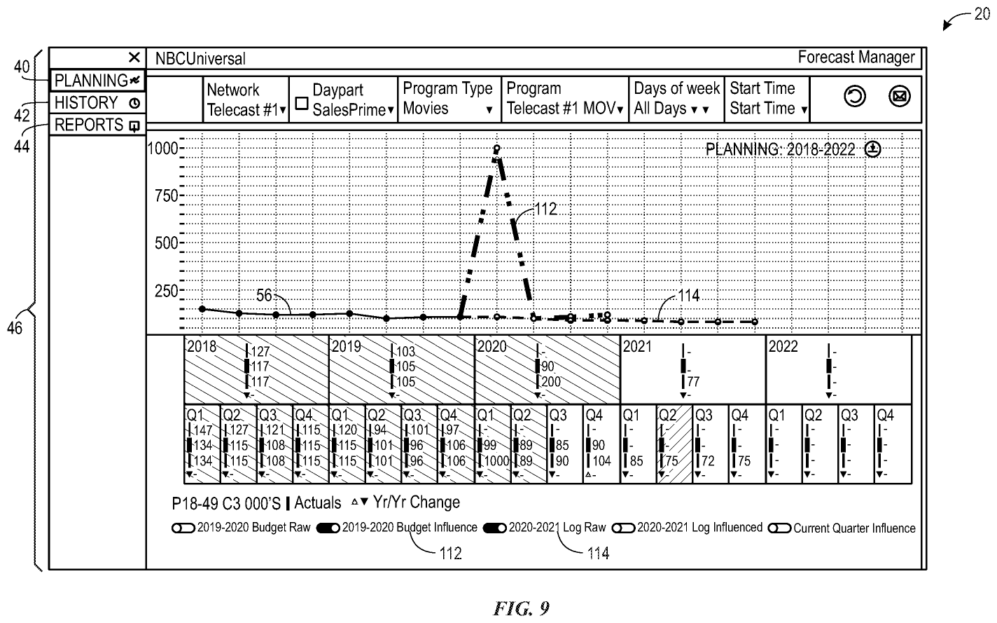

FIG. 9 is the GUI 20 of FIG. 7 that further depicts a trend line using data from a long-range forecast model in the planning view of the window 46, in accordance with an embodiment of the present disclosure. By selecting 112 and 114, the trend line 56 associated with the actual values, the trend line 112 associated with the influenced values from the influenced forecast model, and the trend line 114 associated with values from the long-range forecast model are depicted over a span of time. In some embodiments, values from the long-range forecast model may represent values over a longer period of time compared to the estimate values from the forecast model 16. The long-range values may be useful in to comparing properties (e.g., aggressive behavior) of the forecast model 16 in comparison to the actual values over a greater period of time

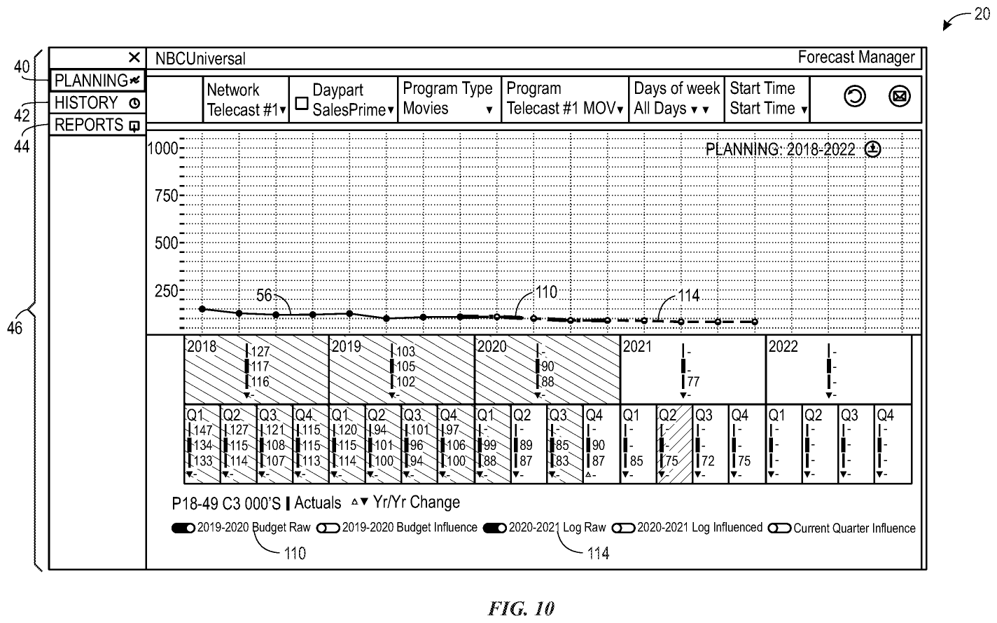

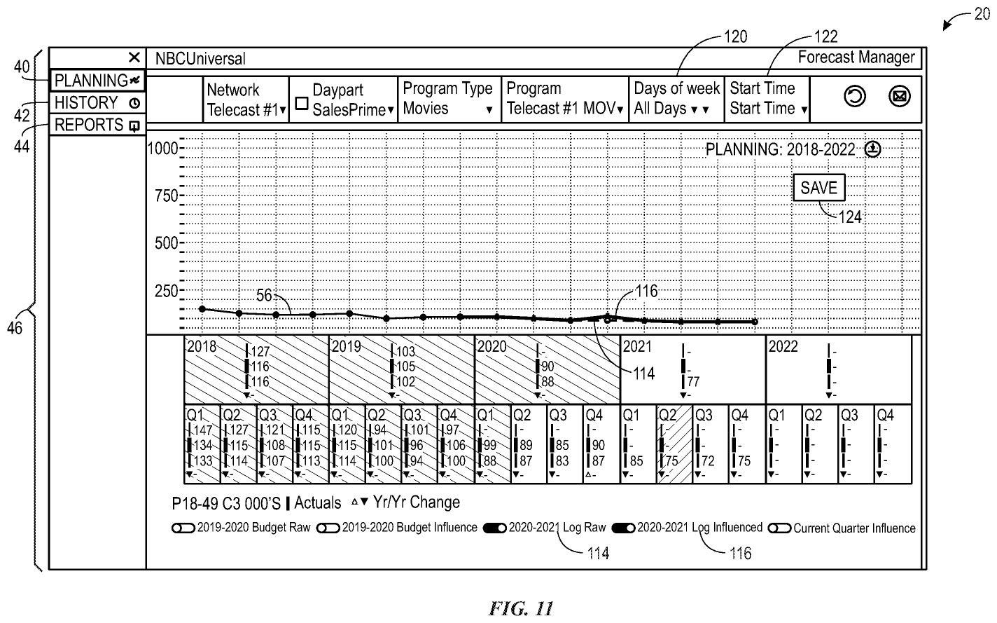

FIG. 10 is the GUI 20 of FIG. 6 that further depicts a trend line using data from the long-range forecast model the planning view of the window 6, in accordance with an embodiment of the present disclosure. By selecting 110 and 114, the trend line 56 associated with the actual values, the trend line 110 associated with the estimate values from the forecast model 16, and the trend line 114 associated with values from the long-range forecast model are depicted over a span of time.

FIG. 11 is the GUI 20 that depicts a trend line using data from the long-range forecast model and data from an influenced, long-range forecast model, in accordance with an embodiment of the present disclosure. By selecting 114 and 116, the trend line 56 associated with the actual values, the trend line 114 associated with values from the long-range forecast model, and the trend line 116 associated with the influenced values from the influenced forecast model are depicted over a span of time. In some embodiments, the values from the influenced, long-range forecast model may represent values over a longer period of time compared to the influenced values from the influenced forecast model.

Additional elements of the GUI 20 includes a drop-down menu 120 that may allow the user to select the frequency (e.g., all days, Mondays) of streaming the particular program as well as another drop-down menu 122 that may allow the user to select a particular time (e.g., start time, end time) associated with streaming the particular program. Further the save icon 124 may cause the graphical representation and respective information from window 46 to be saved within the GUI 20.

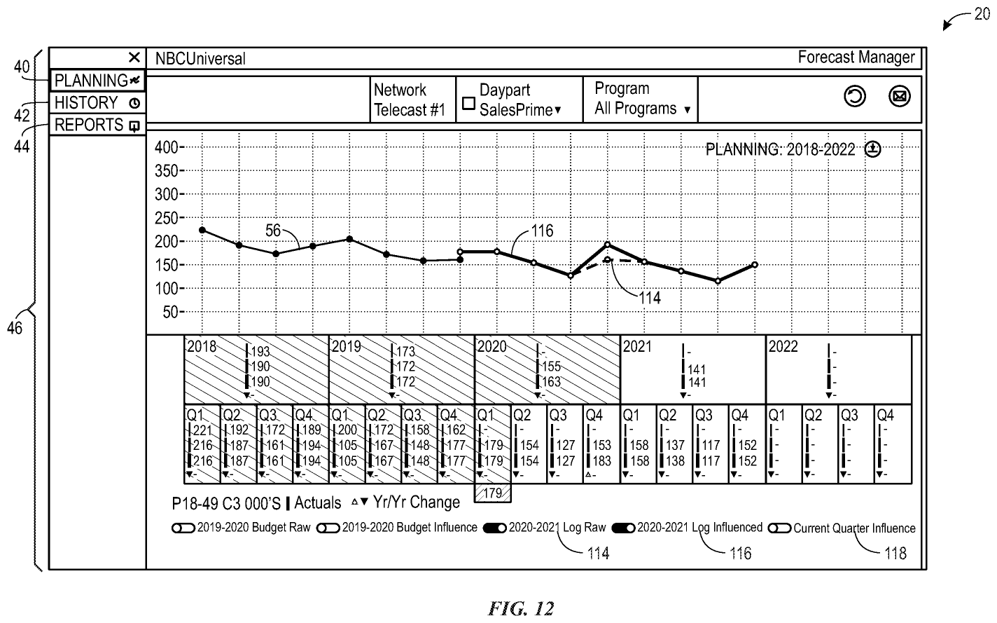

FIG. 12 is the GUI 20 of FIG. 11 that further depicts a trend line using data from an influenced, long range forecast model from a present quarter of time (e.g., Q1), in accordance with an embodiment of the present disclosure. By selecting 114, 116 and 118, the trend line 56 associated with the actual values, the trend line 114 associated with values from the long-range forecast model, and the trend line 116 associated with the influenced values from the forecast model 16 are depicted over the present quarter of time.

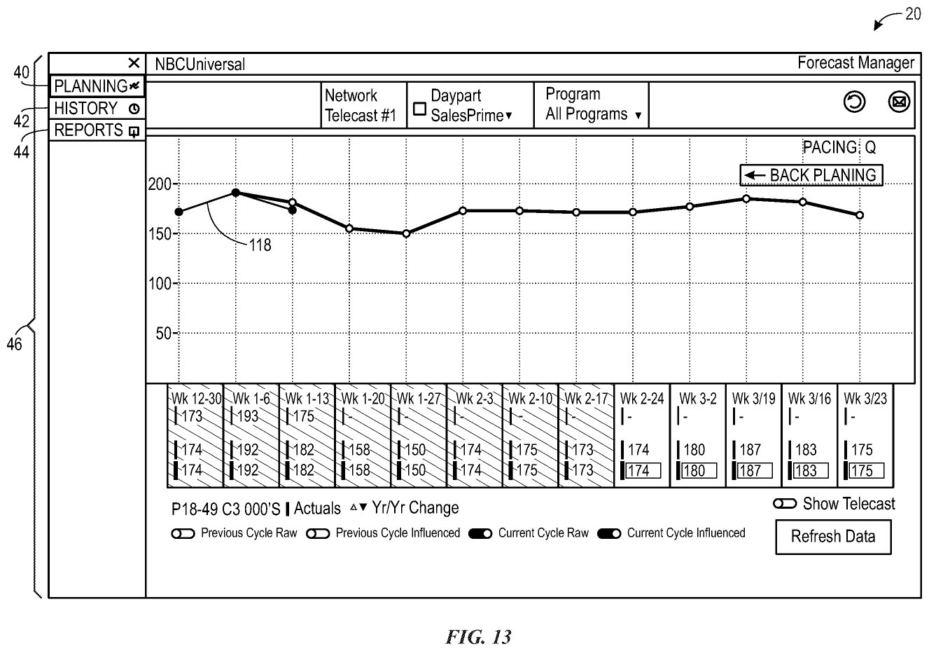

FIG. 13 is the GUI 20 that depicts an enlarged, pacing view of FIG. 12, in accordance with an embodiment of the present disclosure. The pacing view depicts the trend line 114 overlaid on the trend line 116. In this view, actual and forecasted values are listed for various weeks within the particular quarter of time.

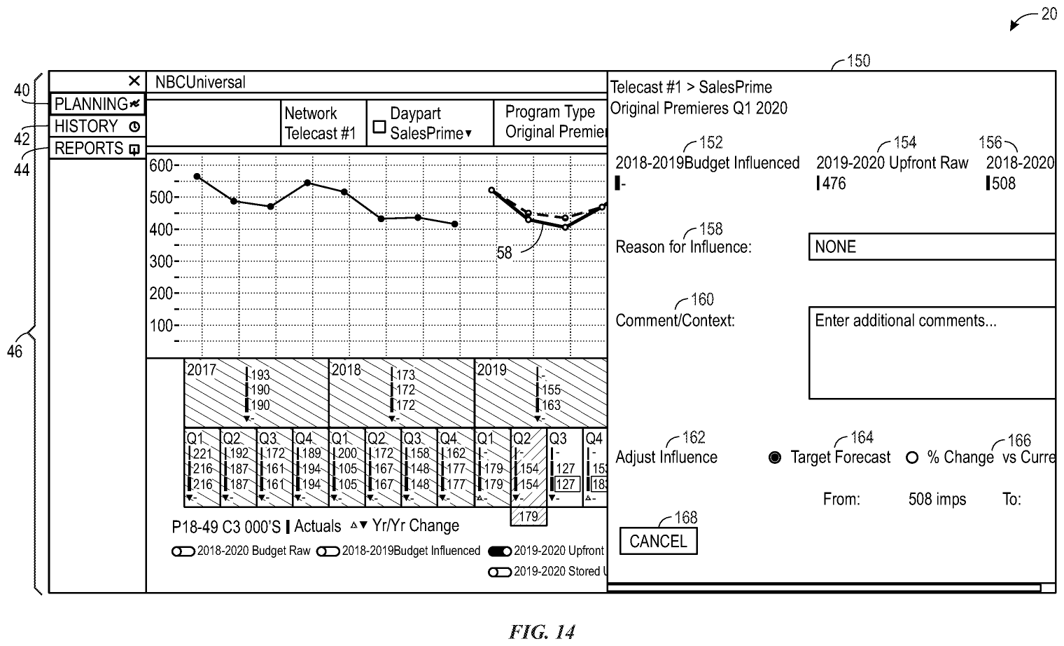

With the preceding in mind, FIG. 14 illustrates a portion of the GUI 20 that depicts the influencing panel 150. As mentioned above, the user or the research team of the telecast provider may be able to influence or update (e.g., change the number of impressions) the forecasts outputted by the forecast model 16. The influencing panel 150 may include user inputs related to the amount of budget influenced 152, the estimate value 154 from the forecast model 16, the influenced value 156 from the influenced forecast model, the reason for the influence 158, comments 160, by how much to adjust the influence 162, and the like. In some embodiments, inputting a reason may be a required action in order to successfully influence the forecast model 16. An example reason for influencing the forecast model 16 may include an expected synergy of two different programs within a telecast, which may lead to a higher number of impressions associated with the telecast. Thus, the research team may influence the forecast model 16 to take into account the impact the synergy of the two programs may have on TV viewership (e.g., increased number of impressions). Adjusting the influence may involve inputting a target forecast value 164 (e.g., 500 impressions) or a percent change 166 (e.g., 25% increase in number of impressions). After successfully influencing the forecast model 16, the trend line 58 associated with the influenced values may also be displayed on the line graph of the window 46.

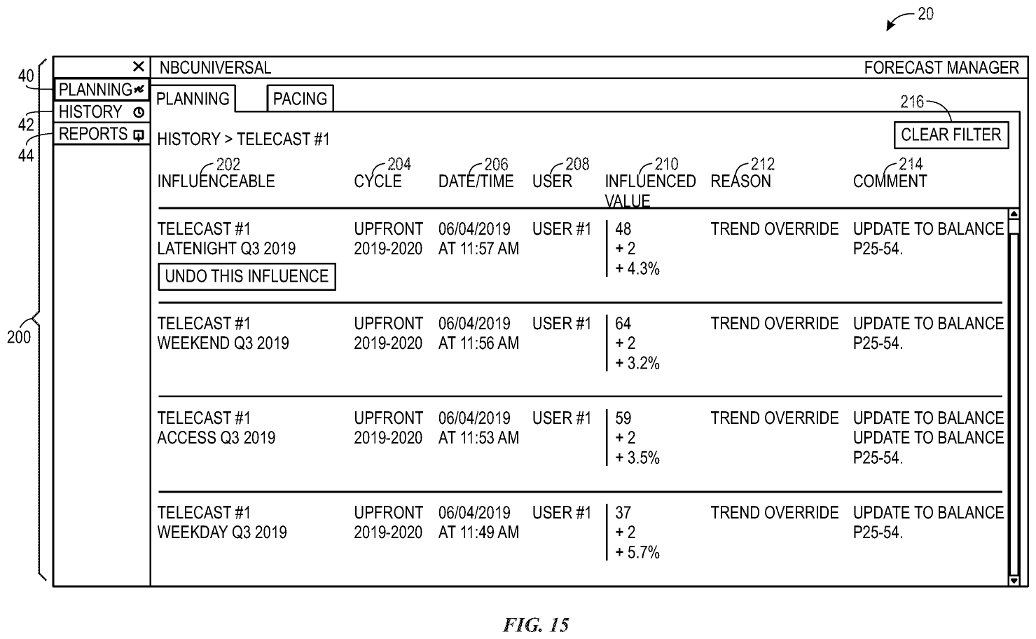

Selecting the tab 42 may lead a user to the history panel. As such FIG. 15 illustrates a portion of the GUI 20 that includes the history panel 200. The history panel 200 captures the influencing history for particular telecasts. Data in the history panel 200 may be categorized based on name of telecast 202, cycle 204, date and time 206, user who entered an influence 208, influenced value 210, reason for the influence 212, additional comments 214, and the like. In some embodiments, the history panel 200 may be searchable by selecting particular filters. In other embodiments, selecting 216 clears the selected filters.

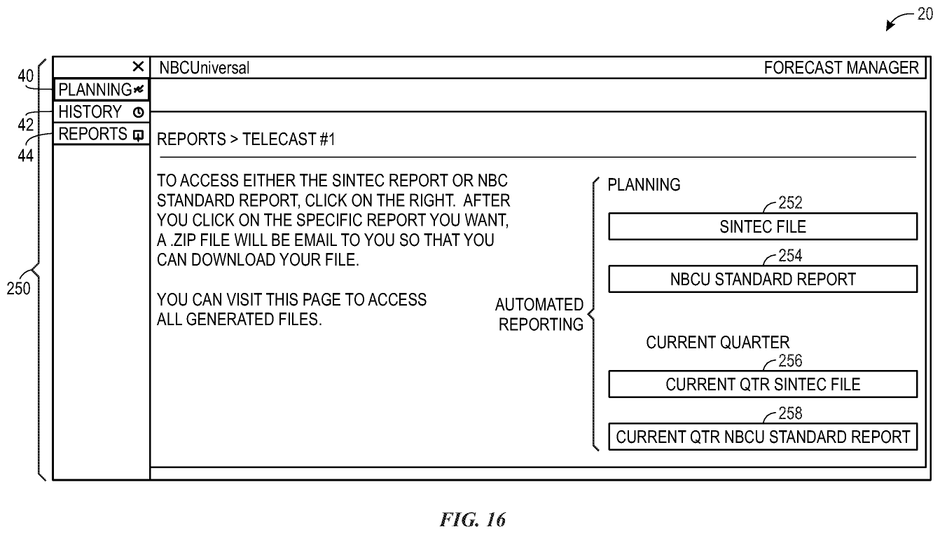

Further, by selecting tab 44, the records panel 250 may be displayed. As such FIG. 16 illustrates a portion of the GUI 20 that includes the records panel 250. The records panel 250 allows information from the planning and history panels to be exported as a zip file, PDF file, and the like. An automated report may be generated based on a selected time period, selected telecast, and the like. For example, the user may have the options of exporting the report as a sintec file 252 or a standard report 254 that may be more user-friendly compared to the sintec file 252. Additionally, the user may have the options of exporting the report as a sintec file for the present quart 256 or as a standard report for the present quarter 258.

In some embodiments, a particular user may be able to only view information in the GUI 20 pertaining to the user. For example, the research team of the telecast provider may only be able to access information designated for research use. In some embodiments, a super user may be able to access any information from the GUI 20. In additional embodiments, the trend lines depicted on the GUI 20 may vary in size, shape, and color (e.g., dashed lines, solid lines, blue lines, orange line, and so forth).

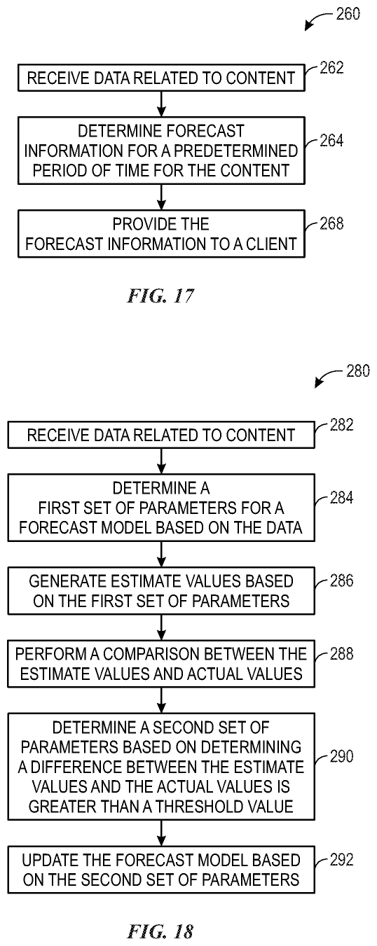

While the FIGS. 4-16 illustrated the GUI 20, which displayed forecast information based on the forecast model 16, the proceeding figures (e.g., FIGS. 17 and 18) describe the process to generate forecast information and update the forecasting model 16 via the forecasting engine (e.g., forecasting system 10). As such, FIG. 17 is a flowchart that depicts a process 260 that provides forecast information for particular content. The forecasting system 10, via a processor, may receive data related to content (block 262). The content may be viewed in the form of digital media, and non-limiting examples of content may include telecasts such as TV shows, advertisements, movies, and so forth. The data related to the content (e.g., telecast) may include start time associated with streaming a telecast, duration of the telecast, frequency of streaming the telecast, genre of the telecast, and the like. Based on evaluating the data related to the content using the machine learning circuitry 14 of FIG. 1, the processor may determine forecast information related to the telecast over a predefined period of time (block 264). In some embodiments, the processor may determine the predefined period of time (e.g. weekly, monthly, yearly) based on run time of a telecast, the number of seasons associated with the telecast, and so forth. In other embodiments, a telecast provider may identify or set the predefined period of time based on data related to the telecast. For example, the telecast provider may set the predefined period of time such that viewership data (e.g., number of impressions) is collected for a popular dance show on a weekly basis.

As described in FIG. 2, the processor may evaluate data related to the telecast and the viewership data using the machine learning circuitry 14 to generate forecast information and provide the forecast information to the telecast provider or another client (block 268). The forecasting system 10, via the machine learning circuitry 14, may generate a forecast model 16 using EDCA or any suitable machine learning algorithm. The forecast model 16 may be trained by obtaining a historical set of telecast data (e.g., actual values), determining initial parameters (e.g., type of content, duration, number of viewers, number of impressions) with respect to an exponential decay model to best fit the telecast data, evaluating parameters algorithmically, and testing the parameters against a test sample. The forecast model 16 is trained using a subset of past or historical telecast data, such that an algorithm (e.g., EDCA) may use available structure or information from the past telecast data to create accurate forecast information. The forecast model 16 learns from different combinations of information from the past telecast data being added to the algorithm. As such, each combination of information from the past telecast data may produce a different prediction or forecast information for the telecast. For example, with respect to the popular dance show, the processor, via the machine learning circuitry 14, may determine that on average the popular dance show has been generally viewed by a higher number of viewers compared to the streaming of a cooking who. However, the processor may also consider that viewership associated with the popular dance show has declined in recent months. Therefore, while the number of viewers may be forecasted to be higher for the popular dance show compared to the cooking show, the processor may estimate that the number of viewers for the popular dance show for next month to be lower than the previous month. The processor may have identified correlations and time dependent observation from past data of the popular dance show to determine the forecasting information. In turn, this forecasting information (e.g., estimate number of viewers for next month) is presented to a telecast provider or client via the GUI 20.

FIG. 18 is a flowchart that depicts a process 280 for updating the forecast model 16 in order to generate accurate forecast information for various telecasts. The forecasting system 10, via a processor, may receive historical data related to content (block 282) from a database that stores data related to any number of content over any period of time. The data related to the content may include genre of the content, number of viewers over a particular time period, duration of the content, and the like. Based on the data, the processor may identify particular parameters to use in generating the forecast model 16 (block 284). The parameters may include the type of content, duration, number of viewers, number of impressions. As detailed in FIG. 18, the processor may determine forecast information or estimate values by generating the forecast model 16 using EDCA or any suitable machine learning algorithm (block 286). Returning to the example of the popular dance show, the processor may identify a parameter associated with number of viewers over a particular time period (e.g., on average 500,000 viewers for every weekly streaming) to generate the forecast model 16. The processor may predict an average of 500,000 viewers for next week's streaming based on the forecast model 16.

After determining forecast information and estimate values, the processor another set of data that correspond to actual values associated with the number of viewership, VPVH, and the like. In turn, the processor, may perform a comparison operation between the estimate values (e.g., forecasting information) and the actual values (block 288). In some embodiments, if the difference between the estimate values and the actual values is greater than a threshold value or percentage (e.g., 1%, 5%, 10%), then the processor may update the forecast model to ensure accuracy when predicting forecast information for future content or telecasts. As such, the processor may identify another set of parameters based on the actual values (block 290). In other embodiments, even if the difference between the estimate values and the actual values is less than the threshold value or percentage, then the processor may still identify the other set of parameters. The processor may use this other set of parameters based on the actual values to update the forecast model 16 (block 292). Updating the forecast model 16 based on the actual values may help in increasing the accuracy of forecast information.

For example, with respect to the popular dance show, the processor an average of 500,000 viewers for next week's streaming; however, the actual number of viewers was 250,000. Since the percent difference (e.g., 50%) between the actual values and estimate values is greater than the threshold percent (e.g., 10%), the processor may identify a new set of parameters and update the forecast model 16 based on the new of parameters. For instance, after evaluating the other set of data that corresponds to the actual values, the processor may determine that another popular event such as the Super Bowl was streaming at the same time as the popular dance show. Viewers that may generally watch the weekly streaming of the popular dance show may have been watching the Super Bowl instead. As such, while the popular dance show may have consistently averaged about 500,000 during its weekly streaming in the past, the processor may update the forecast model 16 after identifying a new viewership parameter that takes into account simultaneous streaming of other popular events such as the Super Bowl. That is, in future predictions, the processor may identify parameters and generates estimate values for a telecast based at least on simultaneous streaming of other popular events (e.g., Super Bowl). In alternative or additional embodiments, if the difference between estimate values and the actual values is value of zero, then the processor may not update the forecast model.

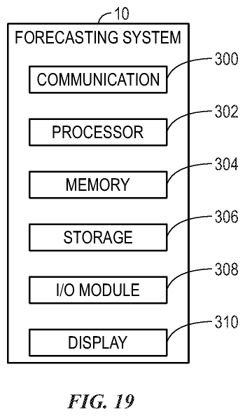

With the foregoing in mind, FIG. 19 illustrates example elements that may be part of the forecasting system 10, in accordance with embodiments presented herein. For example, the forecasting system 10 may include a communication component 300, a processor 302, a memory 304, a storage 306, input/output (I/O) module 308, a display 310, and the like. The communication component 300 may be a wireless or wired communication component that may facilitate communication between the forecasting system 10 and other electronic devices.

The memory 304 and the storage 306 may be any suitable articles of manufacture that can serve as media to store processor-executable code, data, or the like. These articles of manufacture may represent computer-readable media (i.e., any suitable form of memory or storage) that may store the processor-executable code used by the processor 302 to perform the presently disclosed techniques. In some embodiments, the memory 304 may include a volatile data storage unit, such as a random-access memory (RAM) and the storage 306 may include a non-volatile data storage unit, such as a hard disk. The memory 304 and the storage 306 may also be used to store the data, analysis of the data, and the like. The memory 304 and the storage 306 may represent non-transitory computer-readable media (i.e., any suitable form of memory or storage) that may store the processor-executable code used by the processor 302 to perform various techniques described herein. It should be noted that non-transitory merely indicates that the media is tangible and not a signal. The processor 302 may include any suitable number of processors 302 (e.g., one or more microprocessors) that may execute software programs to determine the presence of a laser and provide alerts or notification to a user in response to detecting a light beam from a laser. The processors 302 may process instructions for execution within the forecasting system 10. The processor 302 may include single-threaded processor(s), multi-threaded processor(s), or both. The processor 302 may process instructions and/or information (e.g., control software, look up tables, configuration data) stored in memory device(s) 304 or on storage device(s). The processor 302 may include hardware-based processor(s) each including one or more cores. Moreover, the processor 302 may include multiple microprocessors, one or more “general-purpose” microprocessors, one or more system-on-chip (SoC) devices, one or more special-purpose microprocessors, one or more application specific integrated circuits (ASICs), and/or one or more reduced instruction set (RISC) processors. The processor 302 may be communicatively coupled to the other electronic devices. Further, the processor 302 to may be a part of the forecasting circuitry 13 and runs software to determine the estimate values 76. In some embodiments, the processor 302 may also be a part of the machine learning circuitry 14 and runs software to determine correlations and trends from data.

One or more memory devices (collectively referred to as the “memory device 304”) may include a tangible, non-transitory, machine-readable medium, such as a volatile memory (e.g., a random access memory (RAM)) and/or a nonvolatile memory (e.g., a read-only memory (ROM), flash memory, a hard drive, and/or any other suitable optical, magnetic, or solid-state storage medium). The memory device 304 may store a variety of information that may be used for various purposes. For example, the memory device 304 may store machine-readable and/or processor-executable instructions (e.g., firmware or software) for the processor 302 to execute. In particular, the memory device 304 may store instructions that cause the processor 302 to determine forecasting information using the machine learning based forecast model.

The forecasting system 10 may also include the input/output (I/O) module 308. The I/O module 308 may enable the forecasting system 10 to communicate with various electronic devices. Input/output (I/O) module 308 may be added or removed from the forecasting system 10 via expansion slots, bays or other suitable mechanisms. In certain embodiments, the I/O modules 308 may be included to add functionality to the forecasting system 10, or to accommodate additional process features. For instance, the I/O module 308 may communicate with other electronic devices or user input devices (e.g., smartphone) to influence or update the forecast model 16 and the corresponding estimate values 76 within the forecasting system 10. It should be noted that the I/O modules 308 may communicate directly to other electronic devices or user input devices through hardwired connections or may communicate through wired or wireless networks, such as Hart or IOLink.

Generally, the I/O modules 308 serve as an electrical interface to the forecasting system 10 and may be located proximate or remote from the forecasting system 10, including remote network interfaces to associated systems. In such embodiments, data may be communicated with remote modules over a common communication link, or network, wherein modules on the network communicate via a standard communications protocol. Many industrial controllers can communicate via network technologies such as Ethernet (e.g., IEEE802.3, TCP/IP, UDP, Ethernet/IP, and so forth), ControlNet, DeviceNet or other network protocols (Foundation Fieldbus (H1 and Fast Ethernet) Modbus TCP, Profibus) and also communicate to higher level computing systems. Several of the I/O modules 308 may transfer input and output signals between the forecasting system 10.

The forecasting system 10 may be equipped with the display 310 (e.g., the GUI 20). The display 310 may provide a user with information about the data received via the communication component 300. The information may include data received from the forecasting system 10 and may be associated with the estimate values 76. The display 310 may also be used by a user to influence or update the forecast model 16 and the corresponding estimate values 76 within the forecasting system 10.

The forecasting system 10 may be implemented as a single computing system or multiple computing systems. The computing systems associated with the forecasting system 10 may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe the forecasting system 10 as a physical device, implementations are not so limited. In some examples, the forecasting system 10 may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A tangible, non-transitory, machine-readable medium, comprising machine-readable instructions that, when executed by one or more processors of a machine, cause the machine to:
access, at the machine, data related to content;
determine, using a forecasting engine, forecast information for a predetermined time period for the content, wherein the forecast information comprises a number of viewers, a number of impressions, a sales value, or any combination thereof; and
provide, to a client device, the forecast information.

2. The machine-readable medium of claim 1, wherein the forecasting engine is trained using an exponentially decaying covariance algorithm.

3. The machine-readable medium of claim 2, wherein the forecast engine is further trained based on a univariate autoregressive integrative moving average (ARIMA) algorithm, a multivariate ARIMA algorithm, a regression algorithm, or any combination thereof.

4. The machine-readable medium of claim 1, wherein the data related to the content comprises start time associated with streaming a telecast, duration of the telecast, frequency of streaming the telecast, genre of the telecast, or any combination thereof.

5. The machine-readable medium of claim 1, wherein the forecast engine is trained based on a historical set of data related to the content.

6. The machine-readable medium of claim 1, wherein the forecast engine is configured to use a best fit model to determine a second set of forecast information based on a second set of data.

7. The machine-readable medium of claim 1, wherein the machine-readable instructions further cause the machine to:
provide, to the client device, the forecast information for the predetermined time period for display on the client device, wherein the forecast information is provided for display adjacent to actual information that is associated with the content and that corresponds to a second time period different from and preceding the predetermined time period.

8. The machine-readable medium of claim 1, wherein the forecast engine defines a weight comprising a relative importance associated with a parameter of a set of parameters corresponding to the content, wherein the set of parameters comprises at least one of a type of content, a content duration, a number of viewers, a number of impressions, or any combination thereof.

9. The machine-readable medium of claim 5, comprising machine readable instructions that cause the machine to:
receive user input for modifying the forecast information;
generate influenced forecast information based on the modified forecast information via the user input; and
provide, to the client device, the forecast information and the influenced forecast information corresponding to the same predetermined time period for display at the client device.

10. A method for training a forecast model, comprising:
acquiring, via a processor, a first set of data related to content;
determining, via the processor, a first set of parameters for an exponential decay covariance algorithm (EDCA) based on the first set of data;
generating, via the processor, one or more estimate values based on the first set of parameters and the EDCA;
performing, via the processor, a comparison between the one or more estimate values and one or more actual values associated with a second set of data related to the content;
determining, via the processor, a second set of parameters based on the second set of data in response to determining a difference between the one or more estimate values and the one or more actual values is greater than a threshold value; and
updating, via the processor, the forecast model and the EDCA with the second set of parameters.

11. The method of claim 10, wherein the first set of data related to the content comprises historical data related a telecast.

12. The method of claim 10, wherein the first set of parameters and the second set of parameters comprise a type of content, a content duration, a number of viewers, a number of impressions, or any combination thereof.

13. The method of claim 10, further comprising performing, via the processor, machine learning using the updated forecast model.

14. The method of claim 10, further comprising estimating, via the processor, a mean value based on the first set of data related using the EDCA.

15. The method of claim 14, comprising estimating, via the processor, one or more deviations to the mean value based on the first set of data using the EDCA.

16. The method of claim 15, comprising determining, via the processor, one or more correlations from the first set of data based on the mean value and the one or more deviations using the EDCA.

17. The method of claim 16, comprising performing, via the processor, a second comparison between the one or more correlations from at least two sets of data associated with at least two different telecasts.

18. The method of claim 10, comprising determining, via the processor, a rate of change, an error value, or both based on the comparison between the one or more estimate values and the one or more actual values.

19. A forecasting system, comprising:
one or more processors; and
one or more memory devices configured to store instructions that, when executed by the one or more processors, cause the one or more processors to:
access data related to content;
determine, via machine learning circuitry, forecast information for a predetermined time period for the content, wherein the forecast information comprises a number of viewers, a number of impressions, a sales value, or any combination thereof; and
provide the forecast information to a client device.

20. The forecasting system of claim 19, wherein the machine learning circuitry is trained using an exponentially decaying covariance algorithm.
